(19) United States
(12) Patent Application Publication
(10) Pub. No.: US 2023/0291940 A1
(43) Pub. Date: Sep. 14, 2023

(54) SYSTEMS, APPARATUS AND METHODS TO ENHANCE DELIVERY AND PRESENTATION OF CONTENT

(71) Applicant: InterDigital Patent Holdings, Inc., Wilmington, DE (US)

(72) Inventor: William REDMANN, Glendale, CA (US)

(21) Appl. No.: 18/015,478

(22) PCT Filed: Jun. 30, 2021
(86) PCT No.: PCT/US2021/039850

§ 371 Date: Jan. 10, 2023

Related U.S. Application Data
(60) Provisional application No. 63/052,315, filed on Jul. 15, 2020.

(51) Int. Cl. H04N 21/235; H04H 60/39; H04N 21/258

(52) U.S. Cl. CPC H04N 21/235; H04H 60/39; H04N 21/25825

(57) ABSTRACT

Methods, apparatus, and systems for processing a program schedule to enable presentation of programs can involve obtaining a capabilities expression including at least one capability code indicating a characteristic associated with a program; determining that the characteristic is not required to present the program; and processing the capabilities expression without regard to the at least one capability code to enable presentation of the program.

### TECHNICAL FIELD

The present disclosure involves systems, apparatus, devices and methods for delivering and presenting content.

### BACKGROUND

Systems for delivering and presenting content typically process signals in accordance with a particular standard to ensure compatibility and a seamless user experience. An example of such a standard is the ATSC 3.0 digital television signal standard. In addition to content included in a signal, such as video and audio associated with content including television programming, movies, music, etc., a signal created in accordance with a standard usually includes control information that may relate to a system being able to transmit and/or receive content. The control information may also relate to implementing user interface features such as an electronic program guide. For ease of explanation, the description of the present disclosure and the examples of embodiments described herein will be provided in the context of the example of ATSC 3.0 and devices and systems such as digital televisions, referred to herein as a television or television systems. However, as will be apparent to one skilled in the art, aspects, features and embodiments described herein are also applicable to other standards, methods, systems, apparatus and devices. For example, in addition to television devices, one or more of the examples of embodiments described herein can be applicable to various types of devices, apparatus or systems, with or without a display. Examples of such devices and systems include, but are not limited to, set-top box, gateway device, OTT device (e.g., Apple TV), computer, laptop, mobile device such as a smart phone or tablet, content receiving or processing systems including one or more virtual components or completely based on virtual components (e.g., “in the cloud” such as a DVR feature provided by a head-end service), etc.

The ability to identify a set of capabilities a television must possess is useful when evaluating whether a transmission of content is appropriate for that television. This ability is useful for a television choosing from among a selection of differently formatted media, where each format identifies the capabilities required for its own rendering. This ability is also useful when a television is indicating its own capabilities to another device for the purpose of making such a selection. At least one example of an embodiment described herein improves upon current methods for computing presentability of a content by a television by introducing a new, more compact and efficient mechanism for that computation.

Session Description Protocol (SDP) was described in IETF RFC 2327 SDP: Session Description Protocol, 1998 for describing multimedia sessions for the purposes of session announcement, session invitation, and other forms of multimedia session initiation, and was subsequently obsoleted by IETF RFC 4566 which further defines SDP. An SDP can indicate audio and/or video, a media payload type and identifies certain capabilities relative to the media payload that are further necessary for the media to be useful.

The Real-time Transport Protocol (RTP), was originally standardized by the Internet Engineering Task Force (IETF) RFC 1889 in 1996 and was obsoleted by RFC 3550 in 2003. The RTP documentation explains that RTP “provides end-to-end network transport functions suitable for applications transmitting real-time data, such as audio, video or simulation data, over multicast or unicast network services.” RTP relies on SDP when terminals are negotiating a media connection, to identify required capabilities.

The Open Media Alliance produced the specification OMA TS BCAST, the “Service Guide for Mobile Broadcast Services” in 2013 which describes a schema for announcing service guides for use in digital broadcasting and video-on-demand services. The OMA document relies on SDP to describe media related to a content but to mitigate the complexities of reading each SDP, a portion of the schema provides an item, the TerminalCapabilityRequirement, which identifies the “capabilities needed to consume the service or content”. While the entries in the TerminalCapabilityRequirement are all required, it is possible for the schema to provide multiple entries for a program, each of which can have distinct requirements.

Shortcoming of those approaches is that, in one place, they present only the mandatory capabilities. They further do not characterize the content as well as they might, only the minimum capabilities it takes to play them.

The Advanced Television Standards Committee (ATSC), in developing its suite of standards called ATSC 3.0, includes a standard for Service Announcement: A/332:2017. The service announcement (SA) is used by a television to find channels to present, to construct an electronic program guide (EPG) to present to a viewer, whereby the viewer can understand which program is currently playing, what other programs are currently available, what programs are available next, and so on to programs that are available weeks from now. The EPG is provided by multiple services, e.g., each broadcaster or other distribution operator can contribute the portion of the guide that represents their content, their services (i.e., channels). The EPG can also represent video-on-demand services and their offerings.

Preferably, the EPG “enables ATSC 3.0 Service providers to describe the ATSC 3.0 Services that they make available”, providing “descriptions of the content offerings and may provide a filtering capability of the content offerings based on user preferences and content properties such as . . . video formats (3D, SD, HD, UD), audio formats (stereo, 5.1, immersive) . . . ”, etc. Where “SD” is standard definition, i.e., video resolution up to about 640 lines, “HD” is high-definition, i.e., video resolution up to about 1080 lines, and UD is ultra-high definition, i.e., video resolution of 2160 lines or even more.

While ATSC A/332:2017 makes use of the Open Media Alliance schema and guide architecture, it provides a number of extensions to improve its performance and expand its ability to describe the content available. In particular, ATSC permits a capabilities expression to be associated with each content, and ATSC defines the grammar for such capabilities expression and identifies the available symbols. This represents a significant improvement over the OMA schema, as capabilities expressions are, in one place, able to describe all of the meaningful presentations that are possible for a particular content. This feature provided for the service announcement by ATSC need not be populated: A capabilities expression for a particular content or service can be empty. If empty, it leaves a receiver (what OMA calls the “terminal”) and herein termed the “television”, to instead rely on the OMA schema's TerminalCapabilityRequirement element, or on the corresponding SDPs to indicate the minimum requirements needed to portray the content or service.

### SUMMARY

In general, at least one example of an embodiment can involve a method for processing a program schedule to enable presentation of programs, wherein the method comprises: receiving a capabilities expression including at least one capability code indicating a characteristic associated with a program; determining that the characteristic is not required to present the program; and processing the capabilities expression without regard to the at least one capability code to enable presentation of the program.

In general, at least one other example of an embodiment can involve a method for processing content to enable presentation of a program included in the content, wherein the method comprises: receiving a plurality of capability codes indicating a plurality of corresponding characteristics associated with the program; determining that the plurality of capability codes includes at least one capability code indicating a one of the plurality of corresponding characteristics not required to present the program; and processing the plurality of capability codes without regard to the at least one capability code to evaluate one or more of the plurality of corresponding characteristics required to present the program.

In general, at least one other example of an embodiment can involve apparatus comprising:

one or more processors configured to process a program schedule to enable presentation of programs, wherein the one or more processors being configured to process the program schedule comprises the one or more processors being further configured to receive a capabilities expression including at least one capability code indicating a characteristic of a program; determine that the characteristic is not required to present the program; and process the capabilities expression without regard to the at least one capability code to enable presentation of the program.

In general, at least one other example of an embodiment can involve apparatus for processing content comprising: one or more processors configured to process content to enable presentation of a program included in the content, wherein the one or more processors being configured to process content comprises the one or more processors being further configured to receive a plurality of capability codes indicating a plurality of corresponding characteristics associated with the program; determine that the plurality of capability codes includes at least one capability code indicating a one of the plurality of corresponding characteristics not required to present the program; and process the plurality of capability codes without regard to the at least one capability code to evaluate one or more of the plurality of corresponding characteristics required to present the program.

In general, at least one other example of an embodiment can involve a method for generating information for presentation in an electronic program guide, wherein the method comprises: processing a plurality of capability codes indicating a plurality of corresponding characteristics associated with a content to be listed in the electronic program guide; determining that the plurality of capability codes includes at least one capability code indicating a one of the plurality of corresponding characteristics not required to present the program; and modifying an indicia included in the electronic program guide to indicate the content has a corresponding optional capability that a device for presenting the content is able to present.

In general, at least one other example of an embodiment can involve apparatus comprising: one or more processors configured to generate information for presentation in an electronic program guide, wherein the one or more processors being configured to generate information comprises the one or more processors being further configured to process a plurality of capability codes indicating a plurality of corresponding characteristics associated with a content to be listed in the electronic program guide; determine that the plurality of capability codes includes at least one capability code indicating a one of the plurality of corresponding characteristics not required to present the program; and modify an indicia included in the electronic program guide to indicate the content has a corresponding optional capability that a device for presenting the content is able to present.

In general, at least one other example of an embodiment can involve a method for efficiently encoding capabilities useful for presenting contents, the method comprising: providing a first representation of a first capability as one selected from a first ccode and a capability_string_code, the first capability being necessary for a first meaningful presentation of a content and not necessary for a second meaningful presentation of the content; constructing, for the content, a capabilities expression with the first representation, wherein one of the construction of the capabilities expression and the first representation are such that a result of a Boolean evaluation of the capabilities expression cannot be influenced regardless of whether the first capability is a capability of a television device; and providing the capabilities expression to a television device; whereby the television device can perform a Boolean evaluation of the capabilities expression to determine whether the television device can present the content and can present to a viewer an indication related to the first capability if the television device supports the first capability and not provide the indication otherwise.

In general, at least one other example of an embodiment can involve a method for efficiently encoding capabilities useful for presenting contents as described herein, wherein the construction of the capabilities expression is such that a result of a Boolean evaluation of the capabilities expression cannot be influenced regardless of whether the first capability is a capability of a television device; a second ccode appears at least twice in the capabilities expression; and, a disjunction of the capabilities expression comprises the second ccode and the first representation; a conjunction within the capabilities expression comprises the second ccode and the disjunction, wherein the conjunction evaluates to false if the second ccode evaluates to false for a television device and the disjunction evaluates to true if the second ccode evaluates to true for the television device, and wherein an evaluation of the conjunction cannot be influenced by any evaluation of the first representation, thereby making the first capability optional.

In general, at least one other example of an embodiment can involve a television receiver comprising: a capabilities analyzer that receives, for a content, a first capabilities expression comprising a first representation of a first capability; a device capabilities store, accessible by the capabilities analyzer; an EPG data store, accessible by the capabilities analyzer; an EPG rendering module, having access to the EPG data store; and a display that presents the output of the EPG rendering module, wherein the capabilities analyzer determines that the first capability is optional based on one of a) a construction of the capabilities expression, or b) the first representation indicating that any result of a Boolean evaluation of the capabilities expression cannot be influenced by whether the first capability is indicated in the device capabilities store, and wherein

the capabilities analyzer evaluates the capabilities expression to produce a result, if the result is false, then the capabilities analyzer inhibits presentation of the content, otherwise, if the capabilities analyzer determines from the device capabilities store that the first capability is supported then the capabilities analyzer provides an indication for the EPG rendering module that the first capability is useable for the content and does not provide the indication otherwise; and the EPG rendering module provides a presentation regarding the content to the display, the presentation comprising an indicia apropos to the first capability based on at least if the indication is provided and not otherwise.

In general, at least one other example of an embodiment can involve a method for efficiently encoding capabilities useful for presenting contents, the method comprising: providing a first representation of a first capability as one selected from a first numeric code and a first string code, the first capability being necessary for a first meaningful presentation of a content and not necessary for a second meaningful presentation of the content; constructing, for the content, a capabilities expression with the first representation, wherein one of the construction of the capabilities expression and the first representation are such that a result of a Boolean evaluation of the capabilities expression cannot be influenced regardless of whether the first capability is a capability of a television device; and providing the capabilities expression to a television device, wherein the television device performs a Boolean evaluation of the capabilities expression to determine whether the television device can present the content and can present to a viewer an indication related to the first capability if the television device supports the first capability and not provide the indication otherwise.

The above presents a simplified summary of the subject matter in order to provide a basic understanding of some aspects of the present disclosure. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description provided below.

### BRIEF DESCRIPTION OF THE DRAWINGS

The present disclosure may be better understood by considering the detailed description below along with the accompanying figures, wherein:

FIG. 1 illustrates, in block diagram form, an example an embodiment of a device, apparatus or system, e.g., a television receiver, in accordance with the present disclosure;

FIG. 2 shows an example of an EPG, e.g., on a television display, in accordance with the present disclosure;

FIG. 3 illustrates an example of an embodiment in accordance with the present disclosure;

FIG. 4 illustrates another example of an embodiment in accordance with the present disclosure; and

FIG. 5 shows, in block diagram form, an example of an embodiment of a system for implementing one or more aspects, features or embodiments in accordance with the present disclosure.

It should be understood that the figures are provided only as examples to consider along with the following description. The embodiments illustrated in the figures are not necessarily the only possible configurations and, therefore, are not intended to be, and are not, limiting with regard to the various aspects, embodiments and features described herein.

### DETAILED DESCRIPTION

Use of the capabilities expression in the ATSC Service Announcement as described in A/332:2017 is a significant improvement over the previous standards. However, as the video technology and content configurations have become more sophisticated, certain shortcomings in the ATSC Service Announcement are exposed. In particular, certain content characteristics, which may be of significant interest to viewers, are not well represented, leaving a viewer unable to discern the nature of a content with respect to certain video or audio parameters, until the show is being presented. This can be partially remedied by the addition of new capability codes (described in more detail below), which characterize the content more precisely. However, there are issues if the representation of the more detailed descriptions grows too large, issues related to bandwidth, storage, and computational burden, if the capabilities expressions get large and/or complex, due to the number of options available for viewing and/or filtering for content.

In ATSC 3.0 A/332, capability codes each represent a particular capability that a television may or may not have. The television would know its capabilities. In some use cases, a television can report its capabilities, e.g., that it possesses a particular codec. As presently defined, a content may require certain capabilities in order to be meaningfully presented to a viewer (or recorded for later presentation) by the television (e.g., a particular codec may be needed to decode the picture). In this latter regard, the capability codes of ATSC 3.0 are similar to <fmt> parameters in SDPs or the TerminalCapabilityRequirement in OMA TS BCAST.

However, ATSC 3.0 also supplies a “capabilities expression”: An assemblage of Boolean operators (AND, OR) operating on a specific set of capability codes. The codes can represent the requirements for each of one or more ways of presenting a content. The capabilities expression is to be evaluated by a television based on its actual capabilities. The result of the evaluation determines whether or not a particular encoded content is meaningfully playable, i.e., presentable, by the television. E.g, if a television can properly understand video encoded using high-dynamic range (HDR) formats, the capability code for “HDR” would evaluate to “true”. If the television does not have the corresponding capability, or does not even recognize the “HDR” capability code, then the code evaluates as “false”. Either way, the balance of the codes and Boolean operations can be evaluated and the television can determine its ability to play the content: The evaluations reduce the capabilities expression to a single Boolean result, indicating whether (“true”) or not (“false”) a content is useable by the television.

A drawback of the present form of the capabilities expression is that the ability to express a particular technology capability that is useful, perhaps interesting to a viewer but fundamentally optional, i.e., not required to present a program, comes at a significant cost to the size of the expression, which represents an impact not only to communication bandwidth and storage size, but also processing time. At least one example of an embodiment described herein involves a system, apparatus and method using a compressed representation of a capabilities expression that is further is able to enhance an Electronic Program Guide (EPG) also known as an Electronic Service Guide (ESG), or as identified in the ATSC A/332 standard, the “Service Guide” or “on-screen Service Guide”. It is desirable to convey the same or an enhanced meaning while at the same time reducing these burdens relative to the systems and methods as described by ATSC.

Herein, the term “capability code” is used. This can correspond, for example, to the terms “ccode” or “capability_code” as defined in ATSC 3.0 A/332:2107, which are synonyms for a symbol comprising four hexadecimal digits that is allocated by ATSC to representing a specific device capability or device capability group for use in the “capabilities expression” as therein defined. The term “capability code” as use herein also applies to the alternative representation for a specific device capability or device capability group within the capabilities expression in ATSC A/332, called the “capability_string_code”, where such string codes are not necessarily defined by ATSC but which are symbols available from designated Internet Assigned Numbers Authority (IANA) registries, or registries from different sources. This later version of a capability code operates in a similar manner, but utilizes registered strings for the representation. For example, the capability_category_code “0x03” in A/332 identifies the IANA registry “MIME Media Types” which includes among its list of video formats, “video/H265”, which corresponds to ISO/MPEG High-Efficiency Video Codec (HEVC). Thus, HEVC can be identified as a required capability by including the composite capability_string_code “0x03=video/H265”. In general, the 4-hexadecimal digit ccode/capability_code format is more efficient than the capability_string_code format. Other than that, their properties are similar. For the sake of simplicity, the term “capability code” is used throughout to refer to either form.

Many examples herein use mnemonic symbols, e.g., “HEVC”, in lieu of the hexadecimal codes or capability_string_code including the IANA strings, to benefit readability. However, the meaning is made clear so as to correspond to the codes in representations as defined by ATSC or to expressions having similar purpose and operation in video distribution standards besides those published by ATSC.

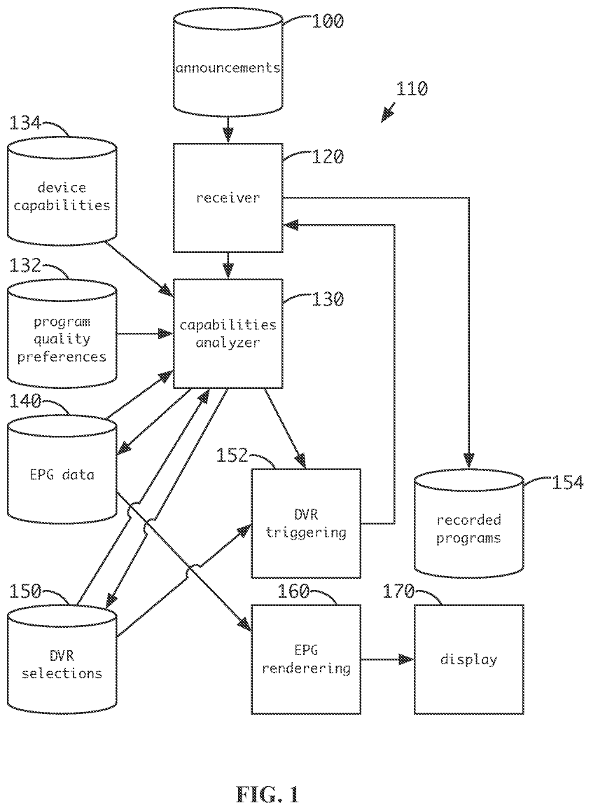

The present disclosure may be better understood by considering the detailed description below along with the accompanying figures. Turning now to the figures, FIG. 1 shows an example of a system block diagram for a device, apparatus or system, e.g. a content receiver, useful for illustrating one or more of the aspects, embodiments and features described herein. For ease of explanation, the example of a system illustrated in FIG. 1 will be referred to herein as a television or television receiver such as a digital television (DTV). However, the content receiver could be any type of electronic device, with or without a display, receiving content including, but not limited to, a television or television receiver (e.g., DTV), a set-top box, a gateway device, an OTT device (e.g., Apple TV), a computer, a laptop, a mobile device such as a smart phone or tablet, content receiving or processing systems including one or more virtual components or completely based on virtual components (e.g., “in the cloud” such as a DVR feature provided by a head-end service), etc. In addition, “content”, “content signal”, or signal providing content” as referenced herein will, for ease of explanation and only as an example, generally be described as providing television content such as television programming, however “content” as used herein can refer to television signals or programming, video content, audio content, movies, etc. Thus, it should be understood that FIG. 1 is provided only as an example and is not necessarily the only possible configuration and, therefore, is not intended to be, and is not, limiting with regard to the various aspects, embodiments and features described herein.

In FIG. 1, program and service announcements 100 from one or more sources are provided to receiver 120 of the example television system 110, as described in ATSC 3.0 A/332 and related documents. In this example embodiment, received announcements are analyzed by a capabilities analyzer 130, e.g., on the basis of program quality preferences 132 (e.g., user preferences specified in a user profile stored and maintained in the system or device) and a representation of the device capabilities 134. The program quality preferences 132 may be predetermined and/or user controlled and/or automatically determined and updated based on user behavior, e.g., a type of content such as HDR content that a user selects. At least a portion of the analysis is based on capabilities expressions as described herein. Device capabilities 134 may be predetermined and/or automatically determined and updated based, for example, on revisions to television firmware (not shown). On the basis of the analysis, a processed announcement can be stored, e.g., in electronic program guide (EPG) data 140. In some cases, the processed announcement is enhanced to denote certain presentation or content characteristics as described below. In some cases, the processed announcement may be a redacted form of the original announcement, or, after analysis, the announcement may be omitted in its entirety and not stored in EPG data 140.

The processed announcements can provide improvements as described herein to EPG rendering 160 which provides the interactive presentation of the EPG to the user on display 170 (conventional interactive controls and control processes for user interaction with the EPG not shown). When the user selects from the EPG display a program to be immediately watched, the receiver 120 selects the corresponding service (not shown) based on the selected EPG data corresponding to the selected program so as to acquire the stream carrying that program from the service and the program is decoded (not shown) and presented on display 170. When the user selects from the EPG display a program to be recorded in the future, particularly on a recurring basis, the selection is noted in DVR selections 150. As announcements are being processed by capabilities analyzer 130, entries in DVR selections 150 are evaluated in the context of the program quality preferences 132 as described below and additional program selections for future recording are noted in DVR selections 150. Subsequently, at the corresponding presentation time for an entry in DVR selections 150, DVR triggering 152 automatically directs receiver 120 to access the corresponding service and program and record it in DVR recorded programs 154.

In at least one example of an embodiment, any or all elements of television system 110 except display 170 and corresponding interaction controls (not shown), including receiver 120, program quality preferences 132, and recorded programs 154, can be physically remote from proximity to the user, e.g., much of the system could be virtualized into the cloud.

A present difficulty with the ATSC A/332 description of capabilities expressions is the ability to express complex content structures efficiently or economically. This is particularly true with respect to any “optional” capability.

A particular capability code, which might be appropriate to a content, is effectively “optional” if an evaluation of a capabilities expression is unchanged whether or not the television has the technological capability corresponding to that particular capability code. An example of this relates to content possessing a particular type of image manipulation metadata called SL-HDR1. A reasonable capabilities expression example (CEE) is shown in CEE 1. It consists of two terms joined in a disjunction. Note that the capabilities expressions shown herein are not presented in the harder-to-read post-fix notation prescribed by the ATSC A/332 standard, but instead are translated, reversibly, into a more intuitively read in-fix notation. The choice of notation herein is only for ease of explanation and does not limit the scope of the present disclosure.

### CEE 1:

(HEVC and AC4 and IMSC1) or
(HEVC and AC4 and IMSC1 and SL-HDR1)
   where:
HEVC represents a capability code for a particular video codec used for the video,
AC4 represents a capability code for a particular audio codec used for the audio,
IMSC1 represents a capability code for a particular encoding used for the captions,
SL-HDR1 represents a capability code for understanding and processing video in accordance with SL-HDR1 metadata, as defined in ETSI TS 103 433-1

In this example capabilities expression, the first term represents a content playable by a television 110 having the right codecs for audio and video and able to understand the captions. These three capabilities are fundamental requirements for ATSC 3.0 televisions operating in North America and would be present for essentially any content being broadcast there. Insofar as “HDR”, the capability code for being able to understand video in one or another high-dynamic range formats, is not present in this capabilities expression, the content is encoded as SDR (standard dynamic range).

The second term is identical to the first, except for the addition the SL-HDR1 capability code. The SL-HDR1 code is “optional” in CEE 1 in two senses: First, in this capabilities expression, whether SL-HDR1 is evaluated by the analyzer 130 to be true or false, the remainder of CEE 1 always produces the same result. Since the first three codes of the second term are the same as the three terms in the first term, the second term can only be true if and only if the first term is also true and the SL-HDR1 capability code also evaluates to be true. Thus, for the purpose of evaluating the overall capabilities expression as being true or false, the SL-HDR1 is completely superfluous. If the first three elements of the second term are true, then the overall capabilities expression is true, regardless of the value of SL-HDR1. This can be seen by extending the first term in accordance with the present disclosure:

### CEE 2:

(HEVC and AC4 and IMSC1 and TRUE) or
(HEVC and AC4 and IMSC1 and SL-HDR1)
   where the addition of a new capability code represented by “TRUE”, which all televisions are to evaluate as being true, to the first term does not change the evaluation of the first term. With that addition, CEE 2 is refactored using the distributive property of conjunction over disjunction to produce the equivalent form:

### CEE 3:

(HEVC and AC4 and IMSC1 and (TRUE or SL-HDR1))
   wherein the sub-expression (TRUE or SL-HDR1) is a tautology, i.e., necessarily true.

The second sense in which the SL-HDR1 capability code is optional is based on the operational behavior of SL-HDR1 metadata: Any television 110 is expected to be able to present SDR video. SL-HDR1 metadata can be optionally provided with SDR video and the metadata is not permitted to interfere with the operation of a television that does not understand or use it. Thus, SL-HDR1 is operationally optional and is constrained to be ignorable. However, for a television that does understand SL-HDR1 metadata and has the capability to use it, it allows the reconstruction of an HDR image from the decoded SDR video, which can produce a pronounced, improved experience for the viewer. However, in the sense of “can a television make a picture with or without the SL-HDR1 metadata being present or useable”, the presence (in the content) or usability (by the television) of the SL-HDR1 metadata does not affect the Boolean evaluation of the capabilities expression.

So why carry a capabilities expression in which such optional capabilities are present at all? On the downside, there is a cost to carrying such optional capability codes. The size of the capabilities expression is more than doubled (from three codes to seven), at least in the form shown in CEE 1, where the first term, which determines the outcome of the equation, has only three capability codes, whereas the second term, which cannot change the outcome of the CEE 1, adds four more terms.

However, the value of carrying such optional capability codes is that the capabilities expression is also used in the construction and presentation of the Service Guide, also called the Channel Guide or Programming Guide, which tells viewers what programs are available now, or next, or tomorrow, or next week. These capabilities expressions are part of the Service Announcement data being presented to viewers and allow the guide to be edited to omit a service or content, if such is the policy, when the viewer's television does not have the ability to present the service or content.

For example, if a TV service (or ‘TV channel’) presents all of its content in HDR but the user does not have an HDR-ready television, then the service might be suppressed in the guide because selecting the service would not display a usable picture.

The value of having the optional capability codes being present, such as in CEE 1, is that an analyzer 130 can choose to do a more detailed analysis of the capabilities expression, rather than the simple Boolean evaluation as presently taught by the ATSC. For example, by analyzing the two terms of CEE 1, an analyzer 130 could determine that the first term represents an SDR presentation of the content and the second term offers the opportunity for an HDR presentation of the content. If the display is able to produce the HDR presentation of the content, as represented by the second term, then the analyzer 130 might choose to note this entry in the EPG data 140 as being a preferable content, e.g., to be particularly highlighted by EPG rendering module 160 for presentation on the display 170 to the viewer, particularly if the viewer has indicated HDR is a preference.

Another value of performing that analysis is that the outcome might be used as the basis for a search or filtering, for example if a user is specifically searching for content having an HDR capability. Of course, other contents directly encoded in HDR and having the “HDR” capability code would be likewise accorded this same highlight and/or search/filter treatment.

There are other examples of optional capability codes which might be added and valuably used this way. A capability code, represented here as “SHVC”, indicates a technology (part of the HEVC H.265 standard) that can add additional resolution to a presentation if the television 110 supports it. Another capability code, represented here as “IMMERSIVE”, ndicates an audio technology (documented as a part of AC4 in ETSI TS 103 190-2 v1.1.1) that delivers an “extension of traditional surround sound reproduction to including higher (spatial) resolution and full 3D audio rendering techniques (including ear-level, overhead and, potentially, floor speakers that are located below the listener) in order to reproduce more realistic and natural auditory cues.”

Consider that the three optional technologies, represented by HDR, SHVC, and IMMERSIVE, are independent. As such, their use in the capabilities expression shown in CEE 4 can be in any of eight possible combinations, from all absent to all present.

### CEE 4:

(HEVC and AC4 and IMSC1) or
(HEVC and AC4 and IMSC1 and SL-HDR1) or
(HEVC and AC4 and IMSC1 and IMMERSIVE) or
(HEVC and AC4 and IMSC1 and SL-HDR1 and IMMERSIVE) or
(HEVC and AC4 and IMSC1 and SHVC) or
(HEVC and AC4 and IMSC1 and SL-HDR1 and SHVC) or
(HEVC and AC4 and IMSC1 and IMMERSIVE and SHVC) or
(HEVC and AC4 and IMSC1 and SL-HDR1 and IMMERSIVE and SHVC)
   In which there are 36 occurrences of capability codes, which is not particularly compact. Alternatively, with the use of the TRUE term as in CEE 3, CEE 4 could be refactored into a single term capabilities expression, as seen in CEE 5.

### CEE 5:

HEVC and AC4 and IMSC1 and
(TRUE or SL-HDR1) and
(TRUE or IMMERSIVE) and
(TRUE or (SL-HDR1 and IMMERSIVE)) and
(TRUE or SHVC) and
(TRUE or (SL-HDR1 and SHVC)) and
(TRUE or (IMMERSIVE and SHVC)) and
(TRUE or (SL-HDR1 and IMMERSIVE and SHVC))
   This uses 22 occurrences of capability codes, including TRUE, SL-HDR1, SHVC, and IMMERSIVE.

However, for the purposes of merely indicating, in the service announcement, whether such optional technologies are present or not, it is only necessary for each of the optional technologies to be appear once. Thus, at least one example of an embodiment provides for a compressed version of the capabilities expression, as shown in CEE 6, that may suffice for most use cases.

### CEE 6:

HEVC and AC4 and IMSC1 and (TRUE or SL-HDR1 or IMMERSIVE or SHVC)
   Note that this compression is lossy compared to CEE 4 and CEE 5. Mathematically, the parenthetical portion of CEE 6 is a redaction of the expansion of the last seven terms in CEE 5, e.g., those that include an optional capability code, as follows. An expansion of those last seven terms looks like, in part:
1 or SL-HDR1 or IMMERSIVE or (SL-HDR1 and IMMERSIVE) or
(SL-HDR1 and IMMERSIVE) or (SL-HDR1 and SL-HDR1 and IMMERSIVE) or
(SL-HDR1 and IMMERSIVE and IMMERSIVE) . . .
   where many appearances are duplicative, e.g., “(SL-HDR1 and IMMERSIVE)” appears twice, other terms appear five more times (not shown), and many of the sub-terms, e.g., “(SL-HDR1 and IMMERSIVE and IMMERSIVE)” include redundant elements. When redundant elements are consolidated, e.g., occurrences of “IMMERSIVE and IMMERSIVE” are replaced by “IMMERSIVE” and the duplicative elements are consolidated, e.g., retaining only one instance of “(SL-HDR1 and IMMERSIVE)” in the overall disjunction, then the intermediate version of the overall compression is CEE 7:

### CEE 7:

HEVC and AC4 and IMSC1 and
(TRUE or SL-HDR1 or IMMERSIVE or (SL-HDR1 and IMMERSIVE) or SHVC or
(SL-HDR1 and SHVC) or (IMMERSIVE and SHVC) or
(SL-HDR1 and IMMERSIVE and SHVC))

However, the last term of CEE 7 (the last three lines) includes several conjunctions of strictly optional elements, such as “(SL-HDR1 and IMMERSIVE)”, “(SL-HDR1 and SHVC)”, “(IMMERSIVE and SHVC)”, and “(SL-HDR1 and IMMERSIVE and SHVC)”. Generally speaking, these do not add meaning for the use case of presenting a guide that might highlight the presence of certain optional technologies and can be eliminated, to give the result as shown in CEE 6. An exception to this would be if there were a specific use case for highlighting or filtering for contents having one or more specific combinations of simultaneously available optional technologies, where such optional technologies were not necessarily all simultaneously present.

For example, if a viewer wanted to search for presentations that simultaneously offered HDR (e.g., by way of SL-HDR1) and immersive audio (as indicated by IMMERSIVE), then it could be valuable for the capabilities expression to explicitly include the conjunction “SL-HDR1 and IMMERSIVE” (wherein the order of their appearance does not matter). However, in the normal preparation of content having such diverse features, it would be unlikely and perhaps counterproductive to make one such optional feature available only at the exclusion of the other. Thus, if a content were available with immersive audio and the content were also available in HDR video, it would be quite unusual if the two technologies were not available together in a common delivery of the content.

Accordingly, while CEE 6 represents a lossy compression of CEE 5, the detailed identification of potential combinations will never matter, except perhaps in extraordinary contrived circumstances, so the lossiness of the compressed capabilities expression is not a concern.

As an alternative example embodiment, rather than providing the capability code represented by “TRUE”, which capability code is defined to be evaluated by analyzer 130 to the Boolean value of true, a capability code selected from the first three in CEE 6 (the same as those in the first term of CEE 4), could be used instead. Since the disjunction of TRUE and the optional capability codes in CEE 6 need not evaluate to be any truer than the conjunction of the foregoing elements, any of those foregoing elements could be used instead of TRUE, as in any of CEE 8-10.

### CEE 8:

HEVC and AC4 and IMSC1 and (HEVC or SL-HDR1 or IMMERSIVE or SHVC)

### CEE 9:

HEVC and AC4 and IMSC1 and (AC4 or SL-HDR1 or IMMERSIVE or SHVC)

### CEE 10:

HEVC and AC4 and IMSC1 and (IMSC1 or SL-HDR1 or IMMERSIVE or SHVC)

As presently defined under ATSC 3.0 A/332, an analyzer 130 evaluates a capability code as being true if the television 110 understands the code and has that capability. An analyzer 130 is supposed to evaluate a capability code as false if it does not have the capability code, or if it does not understand the capability code.

For example, if a capabilities expression were to indicate that the associated content is encoded with a new codec, such a capability represented herein as “VVC” for one of the more recent codecs standardized by MPEG, then that content might be associated with the capabilities expression of CEE 11, which is a copy of CEE 1 with occurrences of HEVC replaced by VVC.

### CEE 11:

(VVC and AC4 and IMSC1) or
(VVC and AC4 and IMSC1 and SL-HDR1)
   Whereas a legacy television might have evaluated the first term of CEE 1 to true, and therefore the entirety of CEE 1, that legacy television would not recognize the first capability code in either term of CEE 11, evaluating the overall capabilities expression of CEE 11 to be false, which is appropriate. That is, a legacy television would fail to decode code-stream created using a new technology codec.

However, in at least one other example of an embodiment, optional capability codes can always be evaluated as true by an analyzer 130, regardless of whether the television has the corresponding capability or not. In this example embodiment, the capability expression in CEE 6 could be written as in CEE 12:

### CEE 12:

HEVC and AC4 and IMSC1 and (SL-HDR1 or IMMERSIVE or SHVC)
   where “TRUE or” has been eliminated from the parenthetical set of optional terms. This has the advantage of further reducing the capabilities expression by one capability code. Further, insofar as optional capability codes SL-HDR1, IMMERSIVE and SHVC are all going to evaluate as true, it matters little whether they are grouped in the disjunction before joining the conjunction portion of the capabilities expression, vs each conjoined with the rest, as in CEE 13.

### CEE 13:

HEVC and AC4 and IMSC1 and SL-HDR1 and IMMERSIVE and SHVC

One drawback of expecting optional capability codes to always evaluate to true is that an analyzer 130 that does not recognize a particular optional capability codes could evaluate an optional capability code as being false, because the code was not recognized at all. While this would not affect the outcome of CEE 6 or CEE 12 for an analyzer 130 that, for example, did not understand the IMMERSIVE (or even a second one of the three optional capability codes presented therein), it would affect evaluation of CEE 13.

To remedy this, in at least one example of an embodiment, capability codes representing an optional capability could be selected from within a predetermined range of the overall range of allowed codes, where all analyzers 130 for all televisions could know that capability codes in that range are optional. Accordingly, even if a new, unfamiliar capability code were to be presented to a legacy analyzer 130, it could recognize that the capability code lies within the predetermined range for optional capability codes and the legacy analyzer 130 could then automatically evaluate the capability code as true, regardless of whether or not the television supports or recognizes the capability code. Meanwhile, for being a capability code unknown to that analyzer 130, when the analyzer 130 is producing the EPG, in EPG rendering module 160, for display to a viewer, EPG rendering 160 need not make any special adaptation or highlighting in the EPG as presented relative to the unknown capability code. Essentially, for the purposes of EPG rendering 160, or for filtering by analyzer 130, or performing a search, the analyzer 130 can ignore capabilities within the predetermined range that are not recognized.

In ATSC 3.0 A/332, all presently issued capability codes are in the range of 0x0100 to 0x06FF, with certain portions of that range being reserved by ATSC. Outside of that range, the code value of 0x0000 is forbidden and codes in the ranges 0x0001-0x00FF and 0x0700-0xFFFF are reserved by ATSC.

For example, “AC4” as used above represents ATSC's actual capability code 0x050B, which is a ccode. “IMSC1” represents 0x050D. A capability code 0x050A is assigned to represent video in the HDR format, and is represented herein in the context of capabilities expressions by “HDR”.

Capability codes to explicitly represent “SL-HDR1”, “SHVC”, “IMMERSIVE”, and “HEVC” are not yet allocated in A/332:2017. However, these codes are illustrative examples and not limiting. That is, whether or not these codes are allocated, and if allocated, whether or not their definitions adhere to the descriptions herein, does not detract or limit the teachings herein, as the examples herein are illustrative and do not limit the scope of potential application of aspects and features described herein to other situations, codes, combinations of codes, etc.

In another example of at least one embodiment, for a predetermined range of possible capability codes, a predetermined bit within the capability codes of the predetermined range can indicate whether or not a capability code from that range is an optional capability code.

Of course, the predetermined range could include all possible capability codes, but that is not strictly necessary. For example, ATSC A/332:2017 presently allocates the range of capability codes from 0x0200 to 0x02FF for capability codes that indicate which specific Forward Error Correction (FEC) algorithm(s) is/are in use. At the moment, most of this range is reserved for ATSC: Only the single capability code 0x0200 is assigned to a specified FEC algorithm. By its nature, an FEC algorithm does not have to be used: It is an optional technology that is used only when there is an error, only when the television 110 supports the FEC algorithm, and only after the television 110 has collected enough data from the FEC portion of the distribution signal to properly compensate for that error. If there are no errors, then the signal is received and decoded without exercising the FEC algorithm. Accordingly, it could be expected that no FEC algorithm would be considered anything but optional and there may be no need to designate any capability code in the range of 0x0200-0x02FF as being anything other than optional, and accordingly, no bit would be needed to indicate this.

From the individual capability codes and subranges of capability codes presently allocated, other than being reserved, by ATSC A/332:2017, namely 0x0200, 0x0500-0x050E, and 0x0600-0x0603, it can be seen that the single-bit values of 0x8000, 0x4000, 0x2000, 0x1000, 0x0800, 0x0080, 0x0040, 0x0020, and 0x0010 correspond to bits in the existing capability codes that are not presently used by any assigned capability code. Caution is appropriate however, as the bit represented by 0x0010 would become used among the allocated capability codes if the set of codes presently in the subrange from 0x0500-0x050E were to grow by just two more codes to produce the new code value 0x0510. Accordingly, 0x0010 is a poor candidate for utilization, and based on the number of technologies represented in this subrange already, so also is 0x0020, which would be encountered if the number of technologies represented by this subrange were to grow by little more than a factor of 2×, which is entirely conceivable. Any of the other single-bit values would be suitable to indicate that a capability code having that bit set was an optional capability code.

Having a bit designated, for a particular range, to indicate whether or not a particular capability code is optional, would make it easy for an analyzer 130 to determine whether a capability code received is or is not an optional capability code, even if the analyzer 130 does not understand or recognize the capability code. Providing a predetermined bit within a predetermined range of capability codes, which could be the entire range of capability codes, allows the predetermined bit to indicate whether or not the capability code is optional, even to devices that are not otherwise familiar with the more specific meaning of the other bits in the capability code.

In one example embodiment, the bit represented by 0x8000, i.e., the most significant bit of a capability code, is designated as the bit that signals whether or not a capability code is optional. If the most significant bit is ‘1’, i.e., true, then the capability code is optional. If the most significant bit is ‘0’, i.e., false, then the capability code is a required capability without which the television 110 could not meaningfully present the associated meaningful presentation of the content.

Consider again CEE 13, duplicated here (with extra spaces) and placed in parallel with CEE 14, using a hexadecimal form for the capabilities codes, as A/332 actually calls for (though still using the informal, but more readable in-fix notation, as previously described):

CEE 13 (repeated from above):
HEVC and AC4 and IMSC1 and SL-HDR1 and IMMERSIVE and SHVC

### CEE 14:

0x0300 and 0x050B and 0x050C and 0x8510 and 0x8511 and 0x8512
   In CEE 14, the last three capability codes are clearly optional, as the most significant bit is set in each. An analyzer 130 evaluating this capabilities expression can evaluate these three capability codes to TRUE without harm, regardless of whether or not the television 110 actually has the corresponding technological capability.

This same technique can be applied for use with the capability_string_code, another form of capability code which may also appear within a capabilities expression, as discussed above. Recall that, as presently described a capability_string_code might look like “0x03=video/H265”, where the hexadecimal portion is the capability category code, which designates a predetermined registry, and the string following the equals sign is supposed to be a string in that registry. As currently defined, the string portion of the capability_string_code must match one of the strings predetermined by IANA. Two approaches are possible without changing the length of the overall capability_string_code.

The first approach is to designate a bit in the capability_category_code to indicate that the capability corresponding to the capability_string_code is optional, e.g., the most significant bit of the capability_category_code (i.e., 0x80). This does have the disadvantage of reducing the potential number of possible registries from 256 down to 128, but it is unlikely that registries will become that numerous, so it is a reasonable design.

The second approach is to amend the string portion in a detectable way, without changing its length. Registered strings are typically expressed in a canonical form, and variously present portions of the string in all lower case, camel case, or all upper case. Digits are common, as are some punctuation characters, e.g., “/”, “-”, “+”. It is likely that comparisons between strings are implemented robustly, and in particular, are case-insensitive. Accordingly, by manipulating the case of the alphabetic characters in a predetermined way, which might be relative to the canonical form, an indication could be added to the string portion that would be detected by analysis and signal the optional nature, without departing from the registered string. One such manipulation to signal an optional capability would be to set the case of alphabetic characters as being upper or lower case based on their position within the string being odd or even. The first character, being odd would be, if alphabetic, upper case. The second character, being even would be, if alphabetic, lower case;

and so on. The test by capabilities analyzer 130, for a capability_string_code would be to assume the capability is option and scan the string portion character by character: If a character is alphabetic and its case corresponds to its position as described, then the determination remains that the capability is optional and the test proceeds to the next character, concluding at the end. However, if the test fails at any alphabetic character, the determination changes to be that the capability is not optional and the test immediately concludes. Other patterns of manipulating case could be likewise provided.

Alternatively, a predetermined addition to the string at a predetermined location would indicate that the corresponding capability is optional. For example, beginning the string portion with “?” would signal that the capability is optional. This is considerably simpler to parse, easy for humans to read, but has the disadvantage of adding one character to the length of the capability_string_code and increases the overall length of the capabilities expression by one for each optional capability_string_ code presented. However, this might be a quite reasonable exchange for the simplicity and has the advantage of not reducing the number of different registries that can be signaled with the capability_category_code.

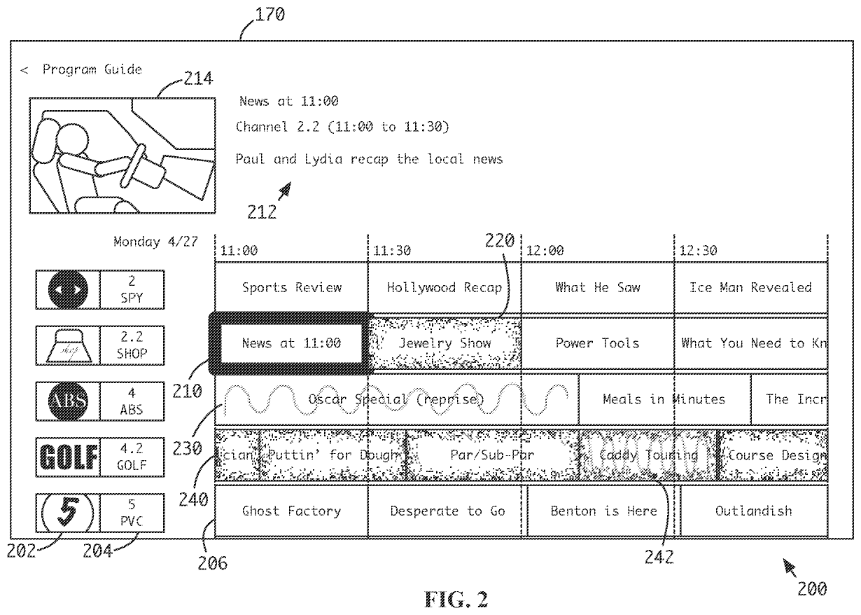

Referring now to FIG. 2, an example of an embodiment of a EPG (a Service Guide) 200 is shown as being presented on display 170 of television 110. EPG 200 can include features such as service icons 202, service names and channel numbers 204, service program entries 206, a currently select program 210, a description 212 for the currently selected program, and a preview 214 of the currently selected show.

The cell 220 representing the “Jewelry Show” is highlighted, e.g., in this case with “sparkles”, or some other indicator that the program is available in a video format other than SDR, e.g., HDR in the present example, and that television 110 considers itself able to present that HDR in a way that differentiates “Jewelry Show” from other presentations that do not have HDR characteristics. Cell 220 might correspond to a content associated with a capabilities expression such as CCE 1 and the television 110 supports SL-HDR1 for use in reconstructing HDR images. Accordingly, “Jewelry Show” would be an enhanced presentation and the EPG renderer 160 chooses to indicate that with the sparkles as shown.

In a similar context, a television that did not understand the SL-HDR1 capabilities code in CCE 1 would not have highlighted the cell for “Jewelry Show” in its rendering of the EPG.

The cell 230 representing “Oscar Special (reprise)” is highlighted, in this case with a wavy line (e.g., a “squiggle”), or some other indicator that the program is available in an enhanced audio format, e.g., with immersive audio and that television 110 considers itself able to present that immersive audio in a way that differentiates the “Oscar Special (reprise)” from other presentation that do not have immersive characteristics. Cell 230 represents a program associated with a capabilities expression such as CCE 15 while most other cells are not. Accordingly, only cell 230 has the particular highlight indicating that it has immersive audio, though no HDR.

### CEE 15:

(HEVC and AC4 and IMSC1 and IMMERSIVE)
   where IMMERSIVE is expected to be recognized by all televisions as an optional capability as discussed in conjunction with CEE 13.

The service providing the programs in row 240 of EPG 200 provides all of its shows in HDR, as indicated by the capability expression for the individual shows. As television 110 considers itself capable of displaying HDR, for example as indicated by the capabilities code of SL-HDR1 in CCE 1. Accordingly, the entire row of programs 240 has the highlight, herein represented, for example, as “sparkles”.

An interesting exception within row 240 is cell 242, which has a highlight, e.g., sparkles, representative of the HDR characteristic, which could be due to SL-HDR1 metadata being indicated in the capabilities expression, and has the additional highlight, the squiggly line, representative of immersive audio. Cell 242 represents a program associated with a capabilities expression such as CEE 4, 5, 6, 7, 8, 9, 10, 12, 13, or 14; of which CEE 12, 13 and 14 are the most efficient and compact. In each of these example capabilities expressions, three optional capability codes are present: SL-HDR1, IMMERSIVE, and SHVC. Insofar as television 110 considers itself able to render HDR in a meaningfully different way than non-HDR programs and it understands the capability code for SL-HDR1, the program “Caddy Touring” represented by cell 242 receives the highlighting indicative of an HDR program, i.e., the sparkles. Insofar as television 110 considers itself able to render immersive audio in a meaningfully different way than non-immersive audio programs and it understands the capability code for IMMERSIVE, the program “Caddy Touring” represented by cell 242 further receives the highlighting indicative of an immersive audio program, represented here by the squiggly line.

A different television, e.g., one that did not understand the IMMERSIVE capability code or that could not meaningfully differentiate the immersive audio presentation from a non-immersive audio presentation, would choose to not highlight the equivalent of cell 242 with the squiggly line or other highlight used to indicate immersive audio programming in its own EPG. Likewise, a different television, e.g., one that did not understand the SL-HDR1 capability code or that could not meaningfully differentiate an HDR presentation from a non-HDR presentation, would choose to not highlight cell 242 with the sparkles or other highlight used to indicate an HDR presentation in its own EPG.

Note that no indication corresponding to SHVC and its enhanced resolution benefits are signaled in EPG 200. This could be because no capabilities expression used for the presentation of EPG 200 signaled SHVC; or this could be because television 110 does not support SHVC; or this could be because preferences 132 indicate that such indications are unimportant (e.g., as a default) or not desired (e.g., as a user preference).

As mention in conjunction with CEE 1, the combination of HEVC, AC4, and IMSC1 is required for essentially all programs delivered via ATSC 3.0 in North America. A slightly different combination, HEVC, MPEG-H (representing a different audio codec), and IMSC1 would represent essentially all programs delivered via ATSC 3.0 in Korea. As a matter of saving, a capabilities group can be defined, essentially a new capability code, but one that represents a predetermined combination of other capability codes. E.g., NORTH_AM could represent a capability code defined as the conjunction of HEVC, AC4, and IMSC1. This would allow CEE 1 to be refactored as “(NORTH_AM) or (NORTH_AM and SL-HDR1)”, which is more economical. Further, an empty capabilities expression represents a content playable by any receiver that complies with the mandatory capabilities for devices within the ecosystem. As HEVC, AC4, and IMSC1 represent mandatory capabilities for ATSC 3.0 television receivers sold in North America, it would be possible to completely omit those elements. If such a reduction were applied to CEE 1, the result would be that the first term is empty, e.g., “( ) or (SL-HDR1)” which is not a well-formed capability expression. The solution would be to either use “NORTH_AM” in the reduced form, i.e., “(NORTH_AM) or (SL-HDR1)”, or to use or “TRUE”, as in “(TRUE) or (SL-HDR1)”. A further reduction could be to omit empty terms, such that the reduced form, in North America, of CEE1 could be CEE 16.

### CEE 16:

SL-HDR1
   where:
SL-HDR 1 is understood by all receivers to be an optional capability code

In at least one example of an embodiment with regard to FIG. 2, user preferences such as those stored in program quality preferences 132, for example as part of a user profile, can further control whether or not optional capabilities are used to amend the guide. For example, if a user does not like the “sparkles” or they do not care about HDR, that embellishment or indicator is not provided in the displayed EPG while one or more other indicators remain, e.g., one for immersive audio could remain. In addition, it will be apparent to one skilled in the art that the described indicators, i.e., sparkles and squiggly lines, can be replaced with any of various other indicators (e.g., icons, colors, characters such as asterisks or stars, patterns such as cross-hatching, etc.) and/or indicators for other available features or enhancements can be included in addition to, or instead of, those described. As mentioned, some or all of such indicators can be controlled subject to user preferences.

Accordingly, at least one example of an embodiment described herein provides a system, device, e.g., a television, or method providing an improved electronic program guide for a television having at least one capability each corresponding to at least one optional capability code in a capabilities expression for a content, wherein the capabilities expression evaluates to true for the first television without regard to the first television having the at least one capability, where in the electronic program guide provides an indicia for the content representative of the at least one of the at least one capability, whereby a viewer is apprised of the content having a corresponding optional capability that the television is able to present.

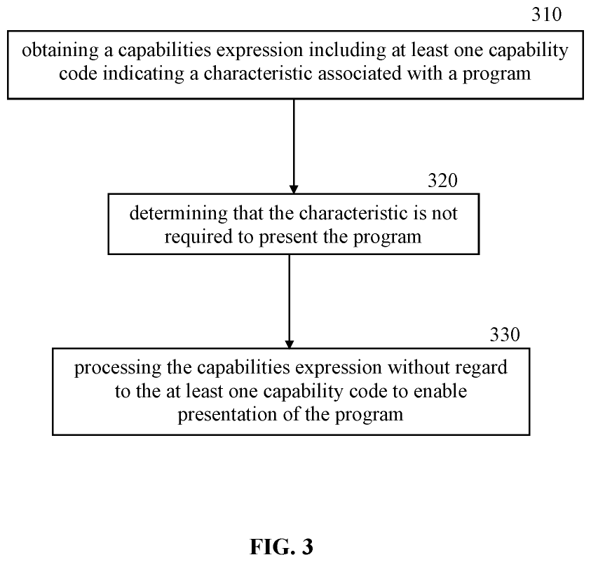

FIG. 3 provides another example of an embodiment. In FIG. 3, at 310 a capabilities expression is obtained, e.g., from a received signal such as in the examples described above. The capabilities expression includes at least one capability code indicating a characteristic associated with a program, e.g., HDR. At 320, it is determined that the characteristic is not required to present the program. Then, at 330, the capabilities expression is processed without regard to the capabilities code. An example of an embodiment such as that illustrated in FIG. 3 is a system processing optional capability codes as described above.

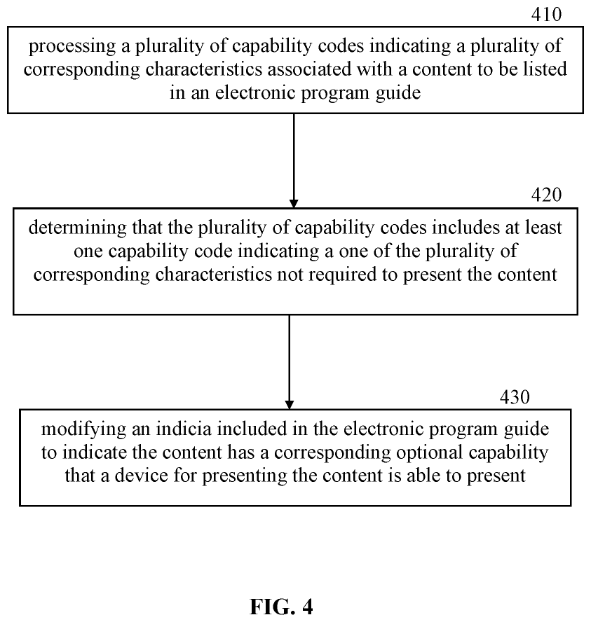

FIG. 4 illustrates another example of an embodiment. In FIG. 4, at 410 processing of a plurality of capability codes occurs. The plurality of capability codes indicate a plurality of corresponding characteristics associated with a content to be listed in an electronic program guide. Operation at 420 determines that the plurality of capability codes includes at least one capability code indicating a one of the plurality of corresponding characteristics not required to present the content. Then, at 430, an indicia included in the electronic program guide is modified to indicate the content has a corresponding optional capability that a device for presenting the content is able to present. An example of the embodiment illustrated in FIG. 4 is described above and illustrated in FIG. 2 where indicia, or an indicator, such as sparkles or a wavy line is included in a program guide an optional capability that a device presenting the content is able to present.

This document describes various examples of embodiments, features, models, approaches, etc. Many such examples are described with specificity and, at least to show the individual characteristics, are often described in a manner that may appear limiting. However, this is for purposes of clarity in description, and does not limit the application or scope. Indeed, the various examples of embodiments, features, etc., described herein can be combined and interchanged in various ways to provide further examples of embodiments.

Various generalized as well as particularized embodiments are also supported and contemplated throughout this disclosure. Examples of embodiments in accordance with the present disclosure include but are not limited to the following.

In general, at least one example of an embodiment can involve a method for processing a program schedule to enable presentation of programs, wherein the method comprises: receiving a capabilities expression including at least one capability code indicating a characteristic associated with a program; determining that the characteristic is not required to present the program; and processing the capabilities expression without regard to the at least one capability code to enable presentation of the program.

In general, at least one other example of an embodiment can involve a method for processing content to enable presentation of a program included in the content, wherein the method comprises: receiving a plurality of capability codes indicating a plurality of corresponding characteristics associated with the program; determining that the plurality of capability codes includes at least one capability code indicating a one of the plurality of corresponding characteristics not required to present the program; and processing the plurality of capability codes without regard to the at least one capability code to evaluate one or more of the plurality of corresponding characteristics required to present the program.

In general, at least one other example of an embodiment can involve a method for processing a program schedule or content as described herein, wherein the plurality of capability codes are associated with a capabilities expression in accordance with requirements established by ATSC.

In general, at least one other example of an embodiment can involve a method for processing a program schedule or content as described herein, wherein at least one capability code corresponds to an optional characteristic.

In general, at least one other example of an embodiment can involve a method for processing a program schedule or content as described herein, wherein processing of a plurality of capability codes comprises evaluating at least one capability code as true without regard to the characteristic associated with the at least one capability code.

In general, at least one other example of an embodiment can involve a method for processing a program schedule or content as described herein, wherein an optional capability code is selected from within a range corresponding to a subset of allowed capability codes.

In general, at least one other example of an embodiment can involve a method for processing a program schedule or content as described herein, wherein each of a subset of allowed capability codes comprises a binary code including a plurality of bits including a designated bit for indicating an optional code.

In general, at least one other example of an embodiment can involve apparatus comprising:

one or more processors configured to process a program schedule to enable presentation of programs, wherein the one or more processors being configured to process the program schedule comprises the one or more processors being further configured to receive a capabilities expression including at least one capability code indicating a characteristic of a program; determine that the characteristic is not required to present the program; and process the capabilities expression without regard to the at least one capability code to enable presentation of the program.

In general, at least one other example of an embodiment can involve apparatus comprising: one or more processors configured to process content to enable presentation of a program included in the content, wherein the one or more processors being configured to process content comprises the one or more processors being further configured to receive a plurality of capability codes indicating a plurality of corresponding characteristics associated with the program; determine that the plurality of capability codes includes at least one capability code indicating a one of the plurality of corresponding characteristics not required to present the program; and process the plurality of capability codes without regard to the at least one capability code to evaluate one or more of the plurality of corresponding characteristics required to present the program.

In general, at least one other example of an embodiment can involve apparatus comprising one or more processors configured to process a program schedule or content as described herein, wherein a plurality of capability codes are associated with a capabilities expression in accordance with requirements established by ATSC.

In general, at least one other example of an embodiment can involve apparatus comprising one or more processors configured to process a program schedule or content as described herein, wherein at least one capability code corresponds to an optional characteristic.

In general, at least one other example of an embodiment can involve apparatus comprising one or more processors configured to process a program schedule or content as described herein, wherein the one or more processors being configured to process a plurality of capability codes comprises the one or more processors being configured to evaluate the at least one capability code as true without regard to the characteristic associated with the at least one capability code.

In general, at least one other example of an embodiment can involve apparatus comprising one or more processors configured to process a program schedule or content as described herein, wherein an optional capability code is selected from within a range corresponding to a subset of allowed capability codes.

In general, at least one other example of an embodiment can involve apparatus comprising one or more processors configured to process a program schedule or content as described herein, wherein each of a subset of allowed capability codes comprises a binary code including a plurality of bits including a designated bit for indicating an optional code.

In general, at least one other example of an embodiment can involve a method for generating information for presentation in an electronic program guide, wherein the method comprises: processing a plurality of capability codes indicating a plurality of corresponding characteristics associated with a content to be listed in the electronic program guide; determining that the plurality of capability codes includes at least one capability code indicating a one of the plurality of corresponding characteristics not required to present the program; and modifying an indicia included in the electronic program guide to indicate the content has a corresponding optional capability that a device for presenting the content is able to present.

In general, at least one other example of an embodiment can involve a method for generating information for presentation in an electronic program guide as described herein, wherein a plurality of capability codes are associated with a capabilities expression in accordance with requirements established by ATSC.

In general, at least one other example of an embodiment can involve a method for generating information for presentation in an electronic program guide as described herein, wherein at least one capability code corresponds to an optional characteristic.

In general, at least one other example of an embodiment can involve a method for generating information for presentation in an electronic program guide as described herein, wherein processing of a plurality of capability codes comprises evaluating at least one capability code as true without regard to the characteristic associated with the at least one capability code.

In general, at least one other example of an embodiment can involve a method for generating information for presentation in an electronic program guide as described herein, wherein an optional capability code is selected from within a range corresponding to a subset of allowed capability codes.

In general, at least one other example of an embodiment can involve a method for generating information for presentation in an electronic program guide as described herein, wherein each of a subset of allowed capability codes comprises a binary code including a plurality of bits including a designated bit for indicating an optional code.

In general, at least one other example of an embodiment can involve apparatus comprising: one or more processors configured to generate information for presentation in an electronic program guide, wherein the one or more processors being configured to generate information comprises the one or more processors being further configured to process a plurality of capability codes indicating a plurality of corresponding characteristics associated with a content to be listed in the electronic program guide; determine that the plurality of capability codes includes at least one capability code indicating a one of the plurality of corresponding characteristics not required to present the program; and modify an indicia included in the electronic program guide to indicate the content has a corresponding optional capability that a device for presenting the content is able to present.

In general, at least one other example of an embodiment can involve apparatus as described herein, wherein a plurality of capability codes are associated with a capabilities expression in accordance with requirements established by ATSC.

In general, at least one other example of an embodiment can involve apparatus as described herein, wherein at least one capability code corresponds to an optional characteristic.

In general, at least one other example of an embodiment can involve apparatus as described herein, wherein one or more processors being configured to process a plurality of capability codes comprises the one or more processors being configured to evaluate at least one capability code as true without regard to the characteristic associated with the at least one capability code.

In general, at least one other example of an embodiment can involve apparatus as described herein, wherein an optional capability code is selected from within a range corresponding to a subset of allowed capability codes.

In general, at least one other example of an embodiment can involve apparatus as described herein, wherein each of a subset of allowed capability codes comprises a binary code including a plurality of bits including a designated bit for indicating an optional code.

In general, at least one other example of an embodiment can involve apparatus as described herein, wherein the apparatus comprises one of a television, a television signal receiver, a set-top box, a gateway device, a mobile device, a cell phone, a tablet, or other electronic device.

In general, at least one other example of an embodiment can involve a non-transitory computer readable medium, or a computer program product, including executable program instructions causing a computer executing the instructions to implement a method in accordance with the present description.

In general, at least one other example of an embodiment can involve a method for efficiently encoding capabilities useful for presenting contents, the method comprising: providing a first representation of a first capability as one selected from a first ccode and a capability_string_code, the first capability being necessary for a first meaningful presentation of a content and not necessary for a second meaningful presentation of the content; constructing, for the content, a capabilities expression with the first representation, wherein one of the construction of the capabilities expression and the first representation are such that a result of a Boolean evaluation of the capabilities expression cannot be influenced regardless of whether the first capability is a capability of a television device; and providing the capabilities expression to a television device; whereby the television device can perform a Boolean evaluation of the capabilities expression to determine whether the television device can present the content and can present to a viewer an indication related to the first capability if the television device supports the first capability and not provide the indication otherwise.

In general, at least one other example of an embodiment can involve a method for efficiently encoding capabilities useful for presenting contents as described herein, wherein: the first representation is such that a result of a Boolean evaluation of the capabilities expression cannot be influenced regardless of whether the first capability is a capability of a television device; the one selected is a first ccode; and a predetermined bit of the first ccode is set and the predetermined bit being set indicates that in any Boolean evaluation, the first ccode evaluates to true.

In general, at least one other example of an embodiment can involve a method for efficiently encoding capabilities useful for presenting contents as described herein, wherein: the predetermined bit applies when the first ccode is within a predetermined range of values and the first ccode is within the range.

In general, at least one other example of an embodiment can involve a method for efficiently encoding capabilities useful for presenting contents as described herein, wherein: the first representation is such that a result of a Boolean evaluation of the capabilities expression cannot be influenced regardless of whether the first capability is a capability of a television device;

the one selected is a first ccode; and the first ccode is within a predetermined range of values and being in the predetermined range of values indicates that in any Boolean evaluation, the first ccode evaluates as true.

In general, at least one other example of an embodiment can involve a method for efficiently encoding capabilities useful for presenting contents as described herein, wherein: the first representation is such that a result of a Boolean evaluation of the capabilities expression cannot be influenced regardless of whether the first capability is a capability of a television device;

the one selected is a capability_string_code; and a predetermined bit of the capability_category_code of the capability_string_code is set and the predetermined bit being set indicates that in any Boolean evaluation, the capability_string_code evaluates as true.

In general, at least one other example of an embodiment can involve a method for efficiently encoding capabilities useful for presenting contents as described herein, wherein: the first representation is such that a result of a Boolean evaluation of the capabilities expression cannot be influenced regardless of whether the first capability is a capability of a television device; the one selected is a capability_string_code; a predetermined character is added to the capability_string_code; and, the predetermined character indicates that in any Boolean evaluation, the capability_string_code evaluates as true.

In general, at least one other example of an embodiment can involve a method for efficiently encoding capabilities useful for presenting contents as described herein, wherein: the construction of the capabilities expression is such that a result of a Boolean evaluation of the capabilities expression cannot be influenced regardless of whether the first capability is a capability of a television device; a second ccode evaluates to true for all television devices; and a disjunction of the capabilities expression comprises the second ccode and the first representation.

In general, at least one other example of an embodiment can involve a method for efficiently encoding capabilities useful for presenting contents as described herein, wherein the construction of the capabilities expression is such that a result of a Boolean evaluation of the capabilities expression cannot be influenced regardless of whether the first capability is a capability of a television device; a second ccode appears at least twice in the capabilities expression; and, a disjunction of the capabilities expression comprises the second ccode and the first representation; a conjunction within the capabilities expression comprises the second ccode and the disjunction, wherein the conjunction evaluates to false if the second ccode evaluates to false for a television device and the disjunction evaluates to true if the second ccode evaluates to true for the television device, and wherein an evaluation of the conjunction cannot be influenced by any evaluation of the first representation, thereby making the first capability optional.

In general, at least one other example of an embodiment can involve a television receiver comprising: a capabilities analyzer that receives, for a content, a first capabilities expression comprising a first representation of a first capability; a device capabilities store, accessible by the capabilities analyzer; an EPG data store, accessible by the capabilities analyzer; an EPG rendering module, having access to the EPG data store; and a display that presents the output of the EPG rendering module, wherein the capabilities analyzer determines that the first capability is optional based on one of a) a construction of the capabilities expression, or b) the first representation indicating that any result of a Boolean evaluation of the capabilities expression cannot be influenced by whether the first capability is indicated in the device capabilities store, and wherein

the capabilities analyzer evaluates the capabilities expression to produce a result, if the result is false, then the capabilities analyzer inhibits presentation of the content, otherwise, if the capabilities analyzer determines from the device capabilities store that the first capability is supported then the capabilities analyzer provides an indication for the EPG rendering module that the first capability is useable for the content and does not provide the indication otherwise; and the EPG rendering module provides a presentation regarding the content to the display, the presentation comprising an indicia apropos to the first capability based on at least if the indication is provided and not otherwise.

In general, at least one other example of an embodiment can involve a television receiver as described herein, wherein the capabilities analyzer provides the indication for the EPG rendering module in the EGP data store.

In general, at least one other example of an embodiment can involve a television receiver as described herein and further comprising: a program quality preferences store, comprising a first preference regarding the first capability, wherein the presentation comprising an indicia apropos to the first capability is further based on the first preference.

In general, at least one other example of an embodiment can involve a television receiver as described herein, wherein, the capabilities analyzer determines that the first capability is optional based on the construction of the capabilities expression; a second ccode evaluates to true for all television devices; and the capabilities code comprises a disjunction, the disjunction comprising the second ccode and the first representation.

In general, at least one other example of an embodiment can involve a television receiver as described herein, wherein the capabilities analyzer determines that the first capability is optional based on the construction of the capabilities expression; a second ccode appears at least twice in the capabilities expression; and a disjunction of the capabilities expression comprises the second ccode and the first representation; a conjunction within the capabilities expression comprises the second ccode and the disjunction, wherein the conjunction evaluates to false if the second ccode evaluates to false for a television device and the disjunction evaluates to true if the second ccode evaluates to true for the television device, whereby an evaluation of conjunction cannot be influenced by any evaluation of the first representation, making the first capability optional.

In general, at least one other example of an embodiment can involve a television receiver as described herein, wherein, the capabilities analyzer determines that the first capability is optional based on the first representation; the first representation is a ccode; and a predetermined bit of the first ccode is set and the predetermined bit being set indicates that in any Boolean evaluation, the first ccode evaluates to true.

In general, at least one other example of an embodiment can involve a television receiver as described herein, wherein: the predetermined bit applies when the first ccode is within a predetermined range of values and the first ccode is within the range.

In general, at least one other example of an embodiment can involve a television receiver as described herein, wherein: the capabilities analyzer determines that the first capability is optional based on the first representation; the first representation is a ccode; and the first ccode is within a predetermined range of values and being in the predetermined range of values indicates that in any Boolean evaluation, the first ccode evaluates as true.

In general, at least one other example of an embodiment can involve a television receiver as described herein, wherein: the capabilities analyzer determines that the first capability is optional based on the first representation; the first representation is a capability_string_code; and

a predetermined bit of the capability_category_code of the capability_string_code is set and the predetermined bit being set indicates that in any Boolean evaluation, the capability_string_code evaluates as true.

In general, at least one other example of an embodiment can involve a television receiver as described herein, wherein: the capabilities analyzer determines that the first capability is optional based on the first representation; the first representation is a capability_string_code; and

a predetermined character is added to the capability_string_code; and the predetermined character indicates that in any Boolean evaluation, the capability_string_code evaluates as true.

In general, at least one other example of an embodiment can involve a method for efficiently encoding capabilities useful for presenting contents, the method comprising: providing a first representation of a first capability as one selected from a first numeric code and a first string code, the first capability being necessary for a first meaningful presentation of a content and not necessary for a second meaningful presentation of the content; constructing, for the content, a capabilities expression with the first representation, wherein one of the construction of the capabilities expression and the first representation are such that a result of a Boolean evaluation of the capabilities expression cannot be influenced regardless of whether the first capability is a capability of a television device; and providing the capabilities expression to a television device, wherein the television device performs a Boolean evaluation of the capabilities expression to determine whether the television device can present the content and can present to a viewer an indication related to the first capability if the television device supports the first capability and not provide the indication otherwise.

In general, at least one other example of an embodiment can involve a method for efficiently encoding capabilities useful for presenting contents as described herein, wherein: the first representation is such that a result of a Boolean evaluation of the capabilities expression cannot be influenced regardless of whether the first capability is a capability of a television device;

the one selected is a first ccode; and a predetermined bit of the first ccode is set and the predetermined bit being set indicates that in any Boolean evaluation, the first ccode evaluates to true.

In general, at least one other example of an embodiment can involve a method for efficiently encoding capabilities useful for presenting contents as described herein, wherein: the predetermined bit applies when the first ccode is within a predetermined range of values and the first ccode is within the range.

In general, at least one other example of an embodiment can involve a method for efficiently encoding capabilities useful for presenting contents as described herein, wherein: the first representation is such that a result of a Boolean evaluation of the capabilities expression cannot be influenced regardless of whether the first capability is a capability of a television device;

the one selected is a first ccode; and the first ccode is within a predetermined range of values and being in the predetermined range of values indicates that in any Boolean evaluation, the first ccode evaluates as true.

In general, at least one other example of an embodiment can involve a method for efficiently encoding capabilities useful for presenting contents as described herein, wherein: the first representation is such that a result of a Boolean evaluation of the capabilities expression cannot be influenced regardless of whether the first capability is a capability of a television device; the one selected is a capability_string_code; and a predetermined bit of the capability_category_code of the capability_string_code is set and the predetermined bit being set indicates that in any Boolean evaluation, the capability_string_ code evaluates as true.

In general, at least one other example of an embodiment can involve a method for efficiently encoding capabilities useful for presenting contents as described herein, wherein: the first representation is such that a result of a Boolean evaluation of the capabilities expression cannot be influenced regardless of whether the first capability is a capability of a television device;

the one selected is a capability_string_code; a predetermined character is added to the capability_string_ code; and the predetermined character indicates that in any Boolean evaluation, the capability_string_code evaluates as true.

In general, at least one other example of an embodiment can involve a method for efficiently encoding capabilities useful for presenting contents as described herein, wherein: the construction of the capabilities expression is such that a result of a Boolean evaluation of the capabilities expression cannot be influenced regardless of whether the first capability is a capability of a television device; a second ccode evaluates to true for all television devices; and a disjunction of the capabilities expression comprises the second ccode and the first representation.

In general, at least one other example of an embodiment can involve a method for efficiently encoding capabilities useful for presenting contents as described herein, wherein: the construction of the capabilities expression is such that a result of a Boolean evaluation of the capabilities expression cannot be influenced regardless of whether the first capability is a capability of a television device; a second ccode appears at least twice in the capabilities expression; and, a disjunction of the capabilities expression comprises the second ccode and the first representation; a conjunction within the capabilities expression comprises the second ccode and the disjunction; wherein the conjunction evaluates to false if the second ccode evaluates to false for a television device and the disjunction evaluates to true if the second ccode evaluates to true for the television device, whereby an evaluation of conjunction cannot be influenced by any evaluation of the first representation, making the first capability optional.

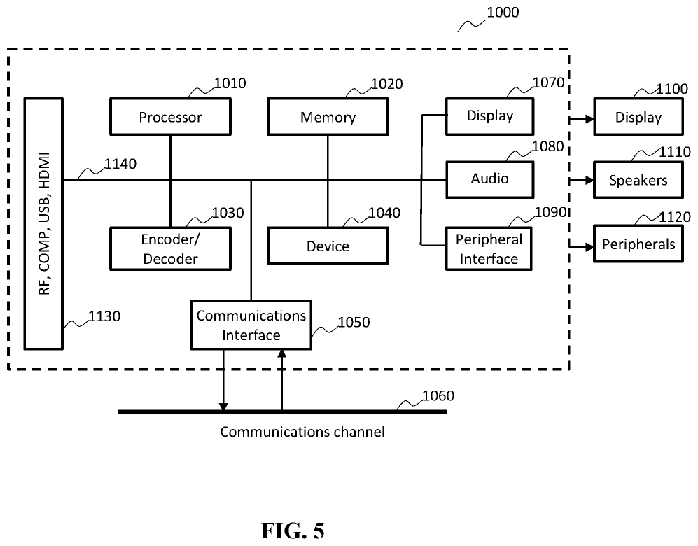

In general, the examples of embodiments described and contemplated in this document can be implemented in many different forms. For example, one or more examples of embodiments can be implemented as a method, an apparatus, a computer readable storage medium having stored thereon instructions for processing data according to any of the methods described, a computer readable storage medium having stored thereon a bitstream or signal generated according to any of the methods described, or a non-transitory computer readable medium storing executable program instructions to cause a computer executing the instructions to perform a method according to any one or more examples of embodiments described herein. FIG. 1 described above and FIG. 5 described below provide some examples of embodiments, but other embodiments are contemplated and the discussion of FIGS. 1 and 5 does not limit the breadth of the implementations. In addition, it should be understood that the drawings provided herein, and sections of text or syntax provided herein that may relate to industry standards or standards-related documents are for purposes of illustrating examples of various aspects and embodiments and are not necessarily the only possible configurations.

Unless indicated otherwise, or technically precluded, the aspects described in this application can be used individually or in combination. Various numeric values are used in the present application, for example, the size of maximum quantization matrix, the number of block sizes considered, etc. The specific values are for example purposes and the aspects described are not limited to these specific values.

FIG. 5 illustrates a block diagram of an example of a system in which various features and embodiments are implemented. System 1000 in FIG. 5 can be embodied as a device including the various components described below and is configured to perform or implement one or more of the examples of embodiments, features, etc. described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In general, the system 1000 is configured to implement one or more of the examples of embodiments, features, etc. described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030, e.g., to perform or implement one or more examples of embodiments, features, etc., described in this document, can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 3, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

The terms HDR (high dynamic range) and SDR (standard dynamic range) are used in this disclosure. Those terms often convey specific values of dynamic range to those of ordinary skill in the art. However, additional embodiments are also intended in which a reference to HDR is understood to mean “higher dynamic range” and a reference to SDR is understood to mean “lower dynamic range”. Such additional embodiments are not constrained by any specific values of dynamic range that might often be associated with the terms “high dynamic range” and “standard dynamic range”.

Various methods are described herein, and each of the methods comprises one or more steps or actions for achieving the described method. Unless a specific order of steps or actions is required for proper operation of the method, the order and/or use of specific steps and/or actions may be modified or combined.

The implementations and aspects described herein can be implemented in, for example, a method or a process, an apparatus, a software program, a data stream, or a signal, e.g., a signal representing an EPG and suitable for display when provided to a display device. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Reference to a “processor” can also indicate one or more processors (e.g., a plurality of or multiple microprocessor or processor integrated circuits) or more than one processor operating to provide the described features or functionality. Processor or processors as used herein can also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this document are not necessarily all referring to the same embodiment.

Additionally, this document may refer to “obtaining” various pieces of information. Obtaining the information can include one or more of, for example, determining the information, estimating the information, calculating the information, predicting the information, or retrieving the information from memory.

Further, this document may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this document may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, “one or more of”, and “at least one of”, for example, in the cases of “A/B”, “A and/or B”, “one or more of A or B” and “at least one of A and B”, is intended to encompass the selection of the first listed option (A) only, or the selection of the second listed option (B) only, or the selection of both options (A and B). As a further example, in the cases of “A, B, and/or C”, “one or more of A, B or C”, and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Various embodiments have been described. Embodiments may include any of the following features or entities, alone or in any combination, across various different claim categories and types:
providing for processing a program schedule to enable presentation of programs including
   receiving a capabilities expression including at least one capability code indicating a characteristic associated with a program; determining that the characteristic is not required to present the program; and processing the capabilities expression without regard to the at least one capability code to enable presentation of the program.
providing for processing content to enable presentation of a program included in the content, including: receiving a plurality of capability codes indicating a plurality of corresponding characteristics associated with the program; determining that the plurality of capability codes includes at least one capability code indicating a one of the plurality of corresponding characteristics not required to present the program; and processing the plurality of capability codes without regard to the at least one capability code to evaluate one or more of the plurality of corresponding characteristics required to present the program.
providing for processing content as described herein, wherein a plurality of capability codes are associated with a capabilities expression in accordance with requirements established by ATSC.
providing for processing content as described herein, wherein at least one capability code corresponds to an optional characteristic.
providing for processing content as described herein, wherein processing of a plurality of capability codes comprises evaluating at least one capability code as true without regard to the characteristic associated with the at least one capability code.
providing for processing content as described herein, wherein an optional capability code is selected from within a range corresponding to a subset of allowed capability codes.
providing for processing content as described herein, wherein each of a subset of allowed capability codes comprises a binary code including a plurality of bits including a designated bit for indicating an optional code.
providing for generating information for presentation in an electronic program guide, including: processing a plurality of capability codes indicating a plurality of corresponding characteristics associated with a content to be listed in the electronic program guide; determining that the plurality of capability codes includes at least one capability code indicating a one of the plurality of corresponding characteristics not required to present the program; and modifying an indicia included in the electronic program guide to indicate the content has a corresponding optional capability that a device for presenting the content is able to present.
providing for generating information for presentation in an electronic program guide as described herein, wherein a plurality of capability codes are associated with a capabilities expression in accordance with requirements established by ATSC.
providing for generating information for presentation in an electronic program guide as described herein, wherein at least one capability code corresponds to an optional characteristic.
providing for generating information for presentation in an electronic program guide as described herein, wherein processing of a plurality of capability codes comprises evaluating at least one capability code as true without regard to the characteristic associated with the at least one capability code.
providing for generating information for presentation in an electronic program guide as described herein, wherein an optional capability code is selected from within a range corresponding to a subset of allowed capability codes.
providing for generating information for presentation in an electronic program guide as described herein, wherein each of a subset of allowed capability codes comprises a binary code including a plurality of bits including a designated bit for indicating an optional code.
providing apparatus as described herein and included in a television, a television signal receiver, a set-top box, a gateway device, a mobile device, a cell phone, a tablet, or other electronic device.
providing a non-transitory computer readable medium, or a computer program product, including executable program instructions causing a computer executing the instructions to implement a method in accordance with the present description.
providing for efficiently encoding capabilities useful for presenting contents, the method comprising: providing a first representation of a first capability as one selected from a first ccode and a capability_string_code, the first capability being necessary for a first meaningful presentation of a content and not necessary for a second meaningful presentation of the content; constructing, for the content, a capabilities expression with the first representation, wherein one of the construction of the capabilities expression and the first representation are such that a result of a Boolean evaluation of the capabilities expression cannot be influenced regardless of whether the first capability is a capability of a television device; and providing the capabilities expression to a television device; whereby the television device can perform a Boolean evaluation of the capabilities expression to determine whether the television device can present the content and can present to a viewer an indication related to the first capability if the television device supports the first capability and not provide the indication otherwise.
providing for efficiently encoding capabilities useful for presenting contents as described herein, wherein: the first representation is such that a result of a Boolean evaluation of the capabilities expression cannot be influenced regardless of whether the first capability is a capability of a television device; the one selected is a first ccode; and a predetermined bit of the first ccode is set and the predetermined bit being set indicates that in any Boolean evaluation, the first ccode evaluates to true.
providing for efficiently encoding capabilities useful for presenting contents as described herein, wherein: the predetermined bit applies when the first ccode is within a predetermined range of values and the first ccode is within the range.
providing for efficiently encoding capabilities useful for presenting contents as described herein, wherein: the first representation is such that a result of a Boolean evaluation of the capabilities expression cannot be influenced regardless of whether the first capability is a capability of a television device; the one selected is a first ccode; and the first ccode is within a predetermined range of values and being in the predetermined range of values indicates that in any Boolean evaluation, the first ccode evaluates as true.
providing for efficiently encoding capabilities useful for presenting contents as described herein, wherein: the first representation is such that a result of a Boolean evaluation of the capabilities expression cannot be influenced regardless of whether the first capability is a capability of a television device; the one selected is a capability_string_code; and a predetermined bit of the capability_category_code of the capability_string_code is set and the predetermined bit being set indicates that in any Boolean evaluation, the capability_string_code evaluates as true.
providing for efficiently encoding capabilities useful for presenting contents as described herein, wherein: the first representation is such that a result of a Boolean evaluation of the capabilities expression cannot be influenced regardless of whether the first capability is a capability of a television device; the one selected is a capability_string_code; a predetermined character is added to the capability_string_code; and, the predetermined character indicates that in any Boolean evaluation, the capability_string_code evaluates as true.
providing for efficiently encoding capabilities useful for presenting contents as described herein, wherein: the construction of the capabilities expression is such that a result of a Boolean evaluation of the capabilities expression cannot be influenced regardless of whether the first capability is a capability of a television device; a second ccode evaluates to true for all television devices; and a disjunction of the capabilities expression comprises the second ccode and the first representation.
providing for efficiently encoding capabilities useful for presenting contents as described herein, wherein the construction of the capabilities expression is such that a result of a Boolean evaluation of the capabilities expression cannot be influenced regardless of whether the first capability is a capability of a television device; a second ccode appears at least twice in the capabilities expression; and, a disjunction of the capabilities expression comprises the second ccode and the first representation; a conjunction within the capabilities expression comprises the second ccode and the disjunction, wherein the conjunction evaluates to false if the second ccode evaluates to false for a television device and the disjunction evaluates to true if the second ccode evaluates to true for the television device, and wherein an evaluation of the conjunction cannot be influenced by any evaluation of the first representation, thereby making the first capability optional.
providing a television receiver comprising: a capabilities analyzer that receives, for a content, a first capabilities expression comprising a first representation of a first capability; a device capabilities store, accessible by the capabilities analyzer; an EPG data store, accessible by the capabilities analyzer; an EPG rendering module, having access to the EPG data store; and a display that presents the output of the EPG rendering module, wherein the capabilities analyzer determines that the first capability is optional based on one of a) a construction of the capabilities expression, or b) the first representation indicating that any result of a Boolean evaluation of the capabilities expression cannot be influenced by whether the first capability is indicated in the device capabilities store, and wherein the capabilities analyzer evaluates the capabilities expression to produce a result, if the result is false, then the capabilities analyzer inhibits presentation of the content, otherwise, if the capabilities analyzer determines from the device capabilities store that the first capability is supported then the capabilities analyzer provides an indication for the EPG rendering module that the first capability is useable for the content and does not provide the indication otherwise; and the EPG rendering module provides a presentation regarding the content to the display, the presentation comprising an indicia apropos to the first capability based on at least if the indication is provided and not otherwise.
providing a television receiver as described herein, wherein the capabilities analyzer provides the indication for the EPG rendering module in the EGP data store.
providing a television receiver as described herein and further comprising: a program quality preferences store, comprising a first preference regarding the first capability, wherein the presentation comprising an indicia apropos to the first capability is further based on the first preference.
providing a television receiver as described herein, wherein, the capabilities analyzer determines that the first capability is optional based on the construction of the capabilities expression; a second ccode evaluates to true for all television devices; and the capabilities code comprises a disjunction, the disjunction comprising the second ccode and the first representation.
providing a television receiver as described herein, wherein the capabilities analyzer determines that the first capability is optional based on the construction of the capabilities expression; a second ccode appears at least twice in the capabilities expression; and a disjunction of the capabilities expression comprises the second ccode and the first representation; a conjunction within the capabilities expression comprises the second ccode and the disjunction, wherein the conjunction evaluates to false if the second ccode evaluates to false for a television device and the disjunction evaluates to true if the second ccode evaluates to true for the television device, whereby an evaluation of conjunction cannot be influenced by any evaluation of the first representation, making the first capability optional.
providing a television receiver as described herein, wherein, the capabilities analyzer determines that the first capability is optional based on the first representation; the first representation is a ccode; and a predetermined bit of the first ccode is set and the predetermined bit being set indicates that in any Boolean evaluation, the first ccode evaluates to true.
providing a television receiver as described herein, wherein: the predetermined bit applies when the first ccode is within a predetermined range of values and the first ccode is within the range.
providing a television receiver as described herein, wherein: the capabilities analyzer determines that the first capability is optional based on the first representation; the first representation is a ccode; and the first ccode is within a predetermined range of values and being in the predetermined range of values indicates that in any Boolean evaluation, the first ccode evaluates as true.
providing a television receiver as described herein, wherein: the capabilities analyzer determines that the first capability is optional based on the first representation; the first representation is a capability_string_code; and a predetermined bit of the capability_category_code of the capability_string_code is set and the predetermined bit being set indicates that in any Boolean evaluation, the capability_string_code evaluates as true.
providing a television receiver as described herein, wherein: the capabilities analyzer determines that the first capability is optional based on the first representation; the first representation is a capability_string_code; and a predetermined character is added to the capability_string_code; and the predetermined character indicates that in any Boolean evaluation, the capability_string_code evaluates as true.
providing for efficiently encoding capabilities useful for presenting contents, the method comprising: providing a first representation of a first capability as one selected from a first numeric code and a first string code, the first capability being necessary for a first meaningful presentation of a content and not necessary for a second meaningful presentation of the content; constructing, for the content, a capabilities expression with the first representation, wherein one of the construction of the capabilities expression and the first representation are such that a result of a Boolean evaluation of the capabilities expression cannot be influenced regardless of whether the first capability is a capability of a television device; and providing the capabilities expression to a television device, wherein the television device performs a Boolean evaluation of the capabilities expression to determine whether the television device can present the content and can present to a viewer an indication related to the first capability if the television device supports the first capability and not provide the indication otherwise.
providing for efficiently encoding capabilities useful for presenting contents as described herein, wherein: the first representation is such that a result of a Boolean evaluation of the capabilities expression cannot be influenced regardless of whether the first capability is a capability of a television device; the one selected is a first ccode; and a predetermined bit of the first ccode is set and the predetermined bit being set indicates that in any Boolean evaluation, the first ccode evaluates to true.
providing for efficiently encoding capabilities useful for presenting contents as described herein, wherein: the predetermined bit applies when the first ccode is within a predetermined range of values and the first ccode is within the range.
providing for efficiently encoding capabilities useful for presenting contents as described herein, wherein: the first representation is such that a result of a Boolean evaluation of the capabilities expression cannot be influenced regardless of whether the first capability is a capability of a television device; the one selected is a first ccode; and the first ccode is within a predetermined range of values and being in the predetermined range of values indicates that in any Boolean evaluation, the first ccode evaluates as true.
providing for efficiently encoding capabilities useful for presenting contents as described herein, wherein: the first representation is such that a result of a Boolean evaluation of the capabilities expression cannot be influenced regardless of whether the first capability is a capability of a television device; the one selected is a capability_string_code; and a predetermined bit of the capability_category_code of the capability_string_code is set and the predetermined bit being set indicates that in any Boolean evaluation, the capability_string_code evaluates as true.
providing for efficiently encoding capabilities useful for presenting contents as described herein, wherein: the first representation is such that a result of a Boolean evaluation of the capabilities expression cannot be influenced regardless of whether the first capability is a capability of a television device; the one selected is a capability_string_code; a predetermined character is added to the capability_string_code; and the predetermined character indicates that in any Boolean evaluation, the capability_string_code evaluates as true.
providing for efficiently encoding capabilities useful for presenting contents as described herein, wherein: the construction of the capabilities expression is such that a result of a Boolean evaluation of the capabilities expression cannot be influenced regardless of whether the first capability is a capability of a television device; a second ccode evaluates to true for all television devices; and a disjunction of the capabilities expression comprises the second ccode and the first representation.
providing for efficiently encoding capabilities useful for presenting contents as described herein, wherein: the construction of the capabilities expression is such that a result of a Boolean evaluation of the capabilities expression cannot be influenced regardless of whether the first capability is a capability of a television device; a second ccode appears at least twice in the capabilities expression; and, a disjunction of the capabilities expression comprises the second ccode and the first representation; a conjunction within the capabilities expression comprises the second ccode and the disjunction; wherein the conjunction evaluates to false if the second ccode evaluates to false for a television device and the disjunction evaluates to true if the second ccode evaluates to true for the television device, whereby an evaluation of conjunction cannot be influenced by any evaluation of the first representation, making the first capability optional.

Various other generalized, as well as particularized embodiments are also supported and contemplated throughout this disclosure.

What is claimed:

1-52. (canceled)

53. A method to utilize service announcements related to transmitted digital content, the method comprising:
receiving, by a receiver, the service announcements comprising characteristics including a plurality of presentations formats representative of the digital content;
analyzing the service announcements and providing an indication of a first presentation format of the plurality of presentations corresponding to a first capability of the receiver;
storing, in an electronic program guide, the indication of the first presentation format of the digital content;
receiving a selection of the digital content having the indication stored in the electronic program guide; and
causing the receiver to access the digital content having the first presentation format for viewing on a display.

54. The method of claim 53, wherein receiving the service announcements further comprises receiving a second presentation format of the plurality of presentations corresponding to a second capability of the receiver, wherein the first presentation format is preferred relative to the second presentation format.

55. The method of claim 53, further comprising:
receiving a selection of other digital content having an indication of a presentation format stored in the electronic program guide, the digital content to be recorded at a future presentation time;
causing the receiver to access the other digital content having the presentation format for recording at the presentation time.

56. The method of claim 55, further comprising accessing a digital video recorder to record the other digital content.

57. The method of claim 53, wherein receiving the service announcements comprises receiving the service announcements using a receiver of at least one of a set top box, a digital television, a gateway device, an over-the-top device, a computer, and a mobile device.

58. The method of claim 53, wherein receiving the service announcements comprises receiving Advanced Television Standards Committee service announcements comprising capability expressions.

59. The method of claim 53, wherein receiving a selection of the digital content having the indication stored in the electronic program guide comprises receiving a selection from a user.

60. The method of claim 53, wherein analyzing the service announcements and providing an indication of a first presentation format of the plurality of presentations corresponding to a first capability of the receiver comprises further analyzing the service announcement based on a quality preference of a user.

61. An apparatus to utilize service announcements related to transmitted digital content, the apparatus comprising circuitry, including a transmitter, a receiver, a processor, and memory, configured to:
receive the service announcements comprising characteristics including a plurality of presentations formats representative of the digital content;
analyze the service announcements and providing an indication of a first presentation format of the plurality of presentations corresponding to a first capability of the receiver;
store, in an electronic program guide, the indication of the first presentation format of the digital content;
receive a selection of the digital content having the indication stored in the electronic program guide; and
access the digital content having the first presentation format for viewing on a display.

62. The apparatus of claim 61, wherein the receiver further receives a second presentation format of the plurality of presentations corresponding to a second capability of the receiver, wherein the first presentation format is preferred relative to the second presentation format.

63. The apparatus of claim 61, further configured to:
receive a selection of other digital content having an indication of a presentation format stored in the electronic program guide, the digital content to be recorded at a future presentation time;
access the other digital content having the presentation format for recording at the presentation time.

64. The apparatus of claim 63, further configured to access a digital video recorder to record the other digital content.

65. The apparatus of claim 61, wherein the apparatus is one of a set top box, a digital television, a gateway device, an over-the-top device, a computer, and a mobile device.

66. The apparatus of claim 61, wherein the receiver receives Advanced Television Standards Committee service announcements comprising capability expressions.

67. The apparatus of claim 61, wherein a user provides the selection of the digital content.

68. The apparatus of claim 61, further configured to analyze the service announcement based on a quality preference of a user.

69. A computer-readable computer medium comprising instructions, which when executed by a processor, performs a method comprising:
receiving, by a receiver, the service announcements comprising characteristics including a plurality of presentations formats representative of the digital content;
analyzing the service announcements and providing an indication of a first presentation format of the plurality of presentations corresponding to a first capability of the receiver;
storing, in an electronic program guide, the indication of the first presentation format of the digital content;
receiving a selection of the digital content having the indication stored in the electronic program guide; and
causing the receiver to access the digital content having the first presentation format for viewing on a display.

70. The computer-readable computer medium of claim 69, wherein receiving the service announcements further comprises receiving a second presentation format of the plurality of presentations corresponding to a second capability of the receiver, wherein the first presentation format is preferred relative to the second presentation format.

71. The computer-readable computer medium of claim 69, further comprising:
receiving a selection of other digital content having an indication of a presentation format stored in the electronic program guide, the digital content to be recorded at a future presentation time;
causing the receiver to access the other digital content having the presentation format for recording at the presentation time.

72. The computer-readable computer medium of claim 69, wherein receiving the service announcements comprises receiving Advanced Television Standards Committee service announcements comprising capability expressions.
